(19) United States
(12) Patent Application Publication
(10) Pub. No.: US 2012/0168582 A1
(43) Pub. Date: Jul. 5, 2012

(54) CORNER BEAD MAGNETIC BRACKET

(76) Inventor: Thomas H. Kelly, Ann Arbor, MI (US)

(21) Appl. No.: 12/981,532

(22) Filed: Dec. 30, 2010

(51) Int. Cl. H01F 7/02

(52) U.S. Cl. 248/206.5

(57) ABSTRACT

A corner bead magnetic bracket has a support portion with at least one magnet embedded therein. The support portion magnetically adheres to a metallic portion embedded in a wall. To increase the magnetic holding power, a washer is placed between the support portion and the magnet. The corner bead magnetic bracket has a shelf portion. To relocate or remove, a user applies enough force to break the magnetic bond and repositions to a new location. Other embodiments include wall and light sconce, vase, curio cabinet, flat shelf, etc. that are easily placed and removed as described above. Rare earth magnets are used to ensure a positive grip.

### BACKGROUND OF THE INVENTION

For as long as humans have lived in dwellings, they have needed shelves. It is impossible to enter a modern house without seeing some kind of shelves, and usually lots of them. Houses built with modern building techniques often include a metallic bead placed on corners when wallboard is used to finish the walls.

In order to personalize the dwelling, decorative items such as lights, wall sconces, peg holders, shelves, curio cabinets, etc. are used to enhance the esthetics of the home. Traditionally, this requires penetrating a finished portion with a nail, hanger or other connecting means. It is known to use non-penetrating fasteners such as adhesive hooks, but these are limited in the amount of weight they can support as well as possible marring of the surface.

There is a need for an easy to attach and remove means to provide shelves, holders, curio cabinets, lights, etc. to an interior space to enhance its usability and esthetic.

### SUMMARY OF THE INVENTION

A corner bead magnetic bracket has a support portion with at least one magnet embedded therein. The support portion magnetically adheres to a metallic portion embedded in a wall. To increase the magnetic holding power, a washer is placed between the support portion and the magnet. The corner bead magnetic bracket has a shelf portion. To relocate or remove, a user applies enough force to break the magnetic bond and repositions to a new location. Other embodiments include wall and light sconce, vase, curio cabinet, flat shelf, etc. that are easily placed and removed as described above. Rare earth magnets are used to ensure a positive grip.

Other features and advantages of the instant invention will become apparent from the following description of the invention which refers to the accompanying drawings.

### BRIEF DESCRIPTION OF THE DRAWINGS

FIG. 1 is a perspective drawing of a corner bead magnetic bracket with an outside shelf according to an embodiment of the invention.

FIG. 2 is a perspective drawing of a corner bead magnetic bracket with an inside shelf according to an embodiment of the invention.

FIG. 3 is a see-through perspective drawing of the corner bead magnetic bracket with an outside shelf shown in FIG. 1.

FIG. 4 is a front view of a corner bead magnetic bracket with shelf according to an embodiment of the invention.

FIG. 5 is a side view of the corner bead magnetic bracket with shelf shown in FIG. 4.

FIG. 6 is a top view of the corner bead magnetic bracket with an outside shelf shown in FIG. 1.

FIG. 7 is a see-through view of the corner bead magnetic bracket with an outside shelf shown in FIG. 1.

FIG. 8 is a front view of a corner bead magnetic bracket with wall vase embodiment.

FIG. 9 is a perspective drawing of a corner bead magnetic bracket with candlestick holder embodiment.

FIG. 10 is a perspective drawing of a corner bead magnetic bracket with peg embodiment.

FIG. 11 is a perspective drawing of a corner bead magnetic bracket with curio cabinet embodiment.

FIG. 12 is a top view of the corner bead magnetic bracket with an outside shelf shown in FIG. 1.

FIG. 13 is a see-through view of the corner bead magnetic bracket with an outside shelf shown in FIG. 1.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

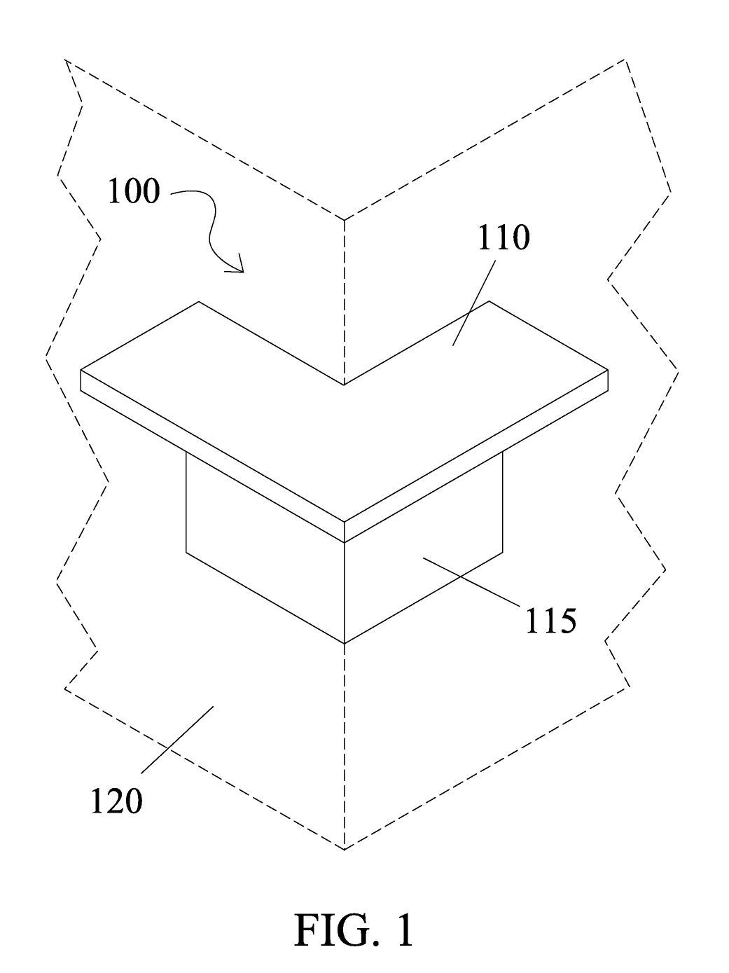

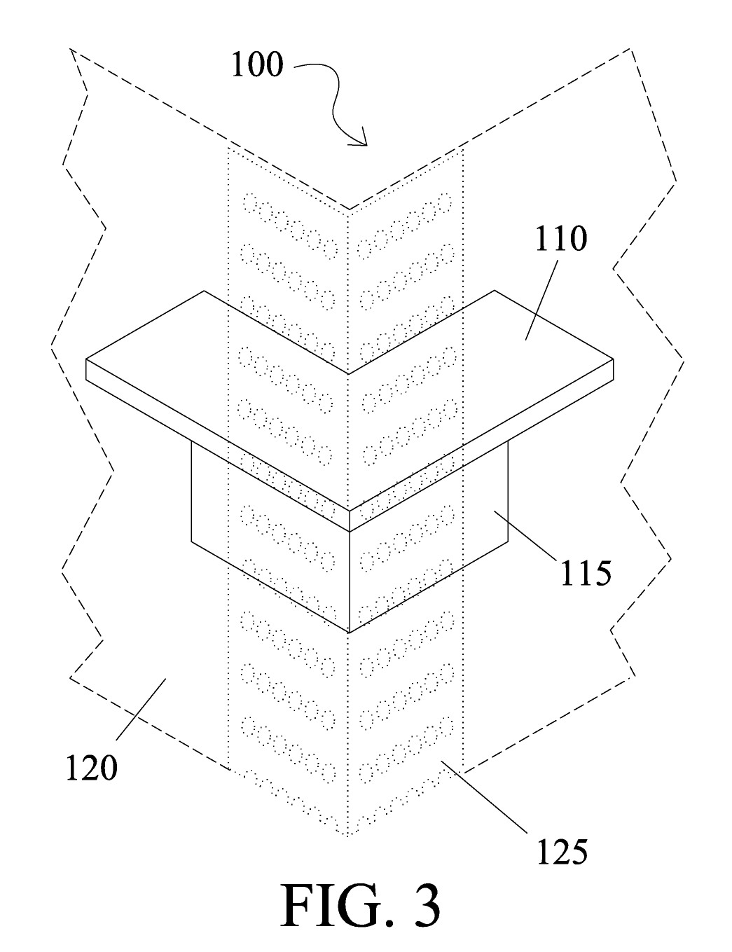

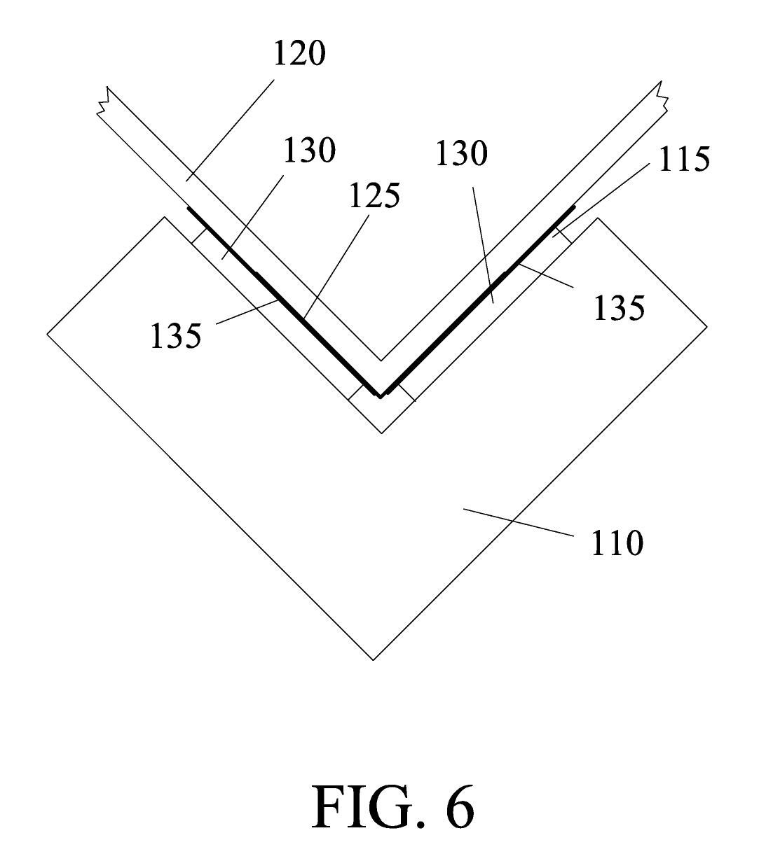

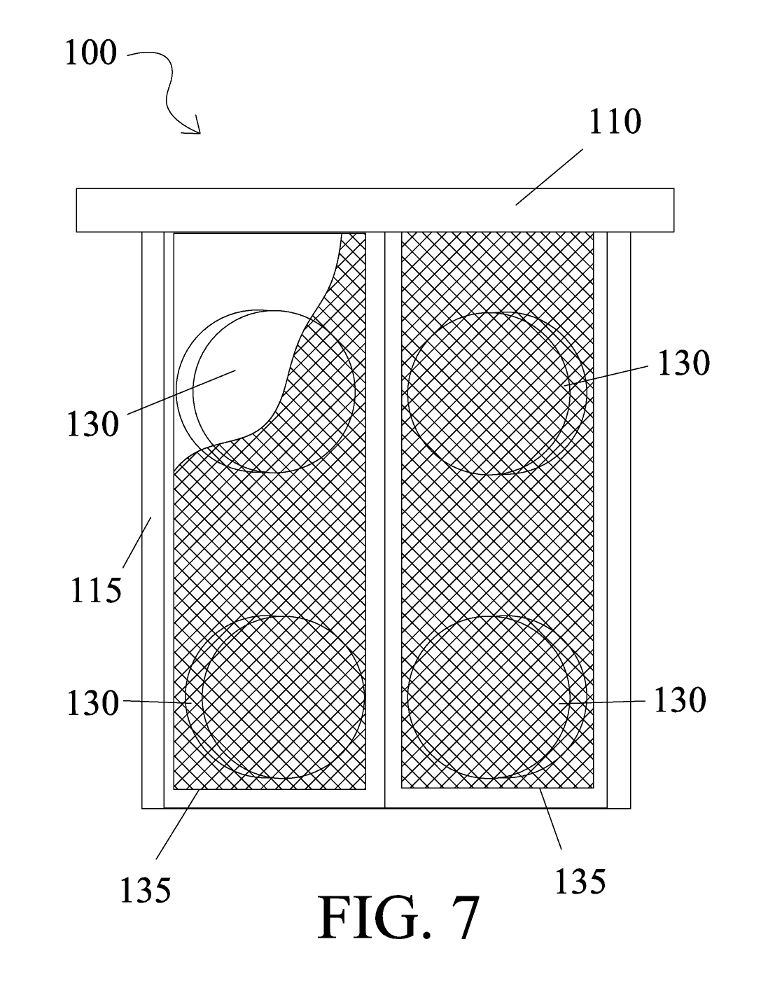

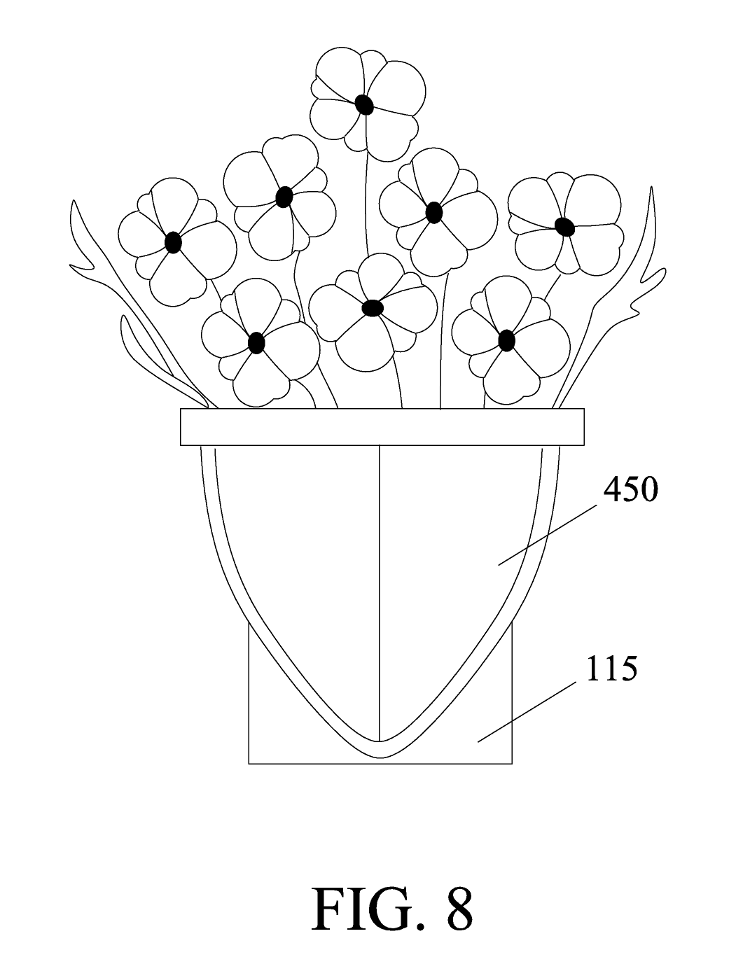

Referring to FIGS. 1, 3, 6 and 7 a corner bead magnetic bracket 100 has a display portion configured in this embodiment as a shelf portion 110 and a support portion 115. Support portion 115 has attached magnets 130 disposed therein with a friction layer 135 covering a substantial portion of the wall facing side of support portion 115. Magnets 130 are rare earth magnets such as neodymium magnets which have a high magnetic flux density. Friction layer 135 is used to increase the friction between a surface 120 and the back surface of support portion 115 helping to hold corner bead magnetic bracket 100 in place. Friction layer 135 is sandpaper or mesh but other friction increasing materials may be used such as rubber or removable adhesives.

Magnets 130 are attracted to a metal drywall corner bead 125 that was installed during construction and is hidden beneath surface 120. Of course, for a corner in which a non-metallic corner bead or no corner bead was used, a metallic corner bead may be applied to the outside surface and painted to match the surface to allow use thereof. The size and number of magnets 130 used may be selected for particular uses and to reduce costs since larger magnets are more expensive than several smaller ones. Additionally, it is possible to eliminate friction layer 135, but the holding power is reduced.

In this embodiment, shelf portion 110 is used to hold objects selected by the user such as clocks, vases, knick-knacks, plates, books, etc. The weight capacity of corner bead magnetic bracket 100 is dependent on the size, type and number of magnets 130 used as well as friction layer 135. Additionally, the length of support portion 115 can be selected to provide more holding capacity by holding more or less magnets depending on use.

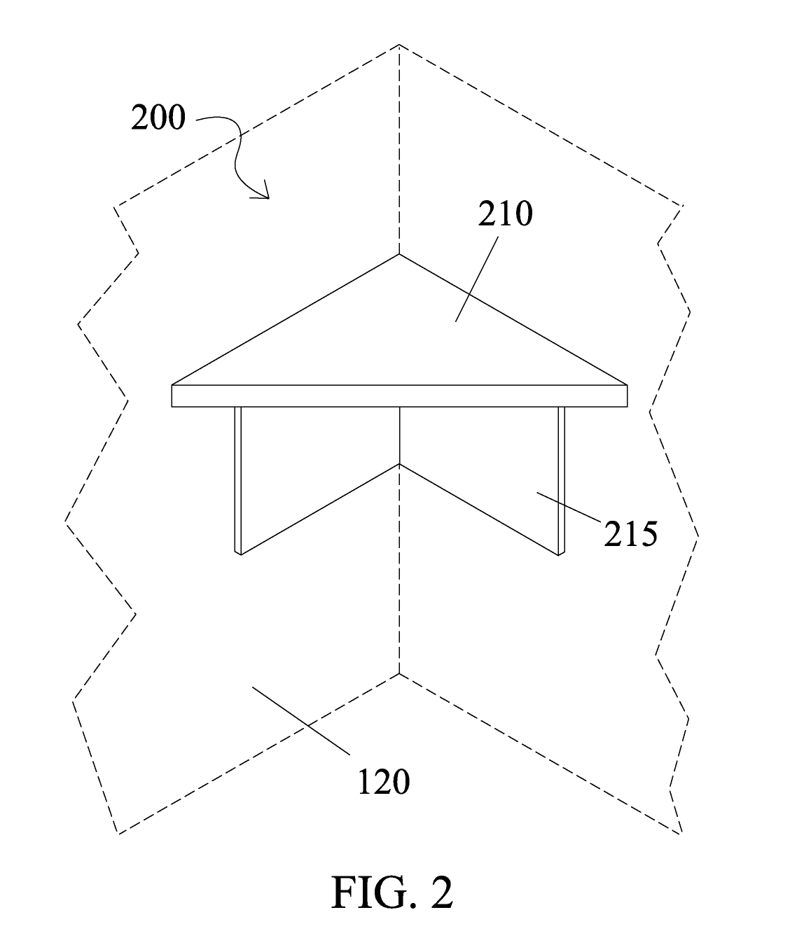

Referring now to FIG. 2, a corner bead magnetic bracket 200 is shown fitting an inside corner and has a support portion 215 and a shelf portion 210. Also, provided are magnets (not shown) and a friction layer (not shown) as discussed above. Again the length of support portion and the size of shelf portion 210 may be selected depending on desired use.

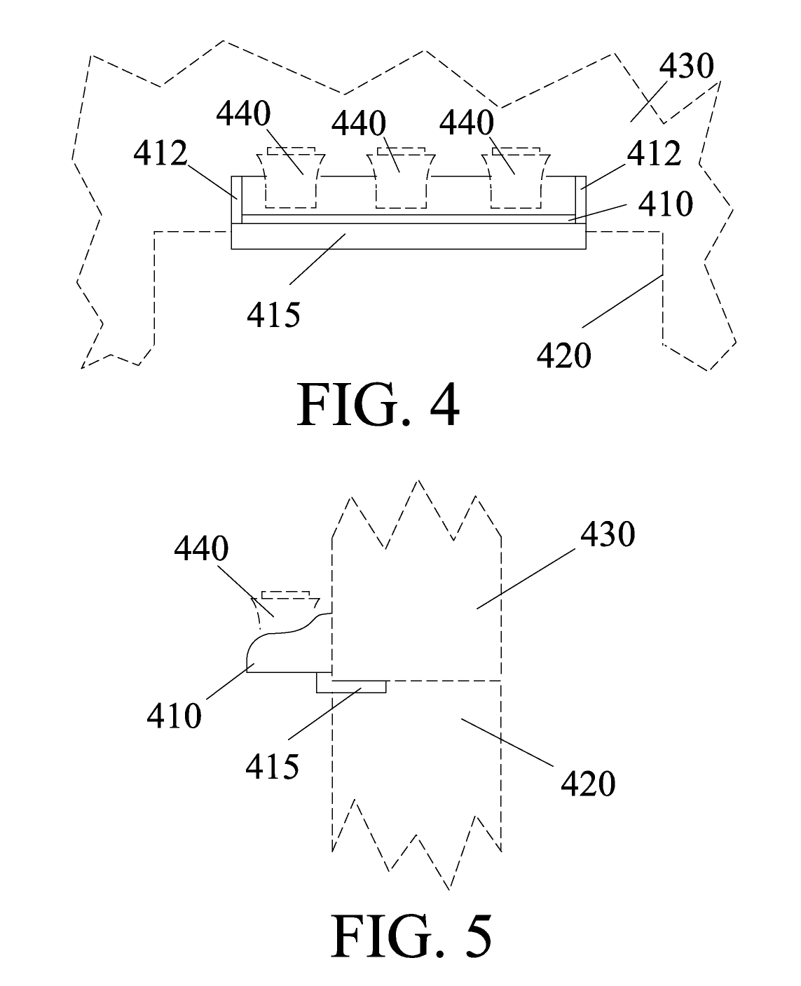

Now referring to FIGS. 4 and 5, a corner bead magnetic bracket is shown having a horizontal shelf portion 410 with a horizontal support portion 415 that fits against a wall opening 420 and a horizontal wall 430 that has an embedded metallic corner bracket (not shown) as discussed above. Horizontal shelf portion 410 has side portion 412 and in this embodiment holds candles 440. Of course other items may be held as discussed above.

Referring now to FIG. 8, a corner bead magnetic bracket 450 is shown having a wall vase portion 450 attached to a support portion 115. Again, other embodiments (not shown) may include wall lights or other decorative wall objects.

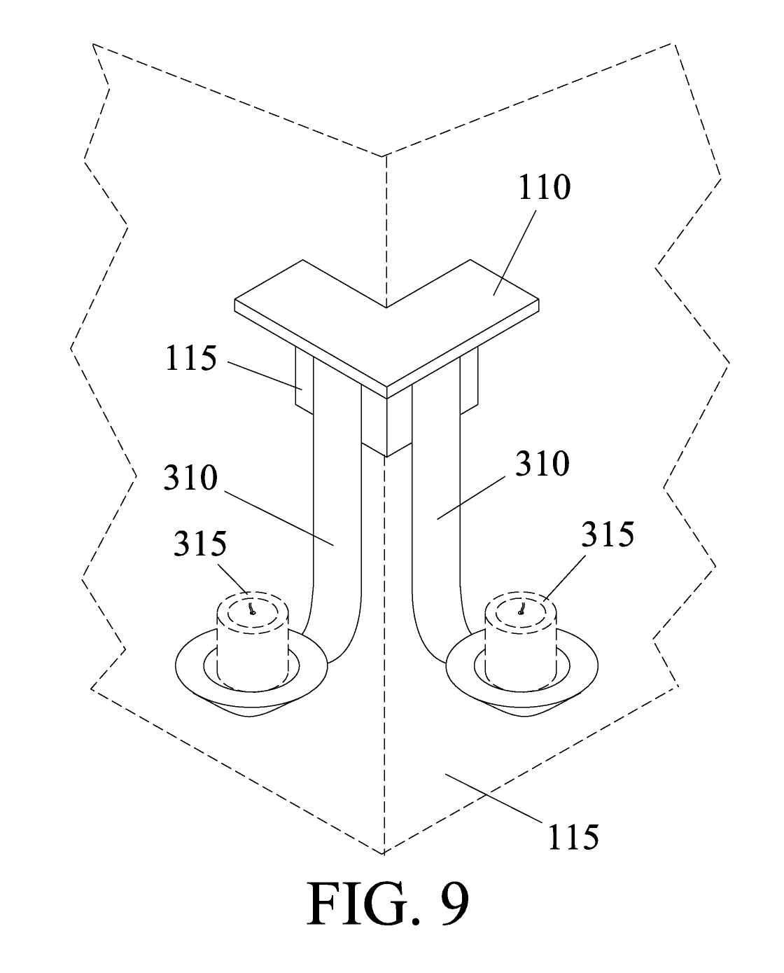

Now referring to FIG. 9, an embodiment is shown having shelf portion 110, support portion 115 with candlestick holders 310 which hold candles 315. In this embodiment, objects may be placed on shelf portion 110 as discussed above. Of course, candles 315 may be other shaped or even electric.

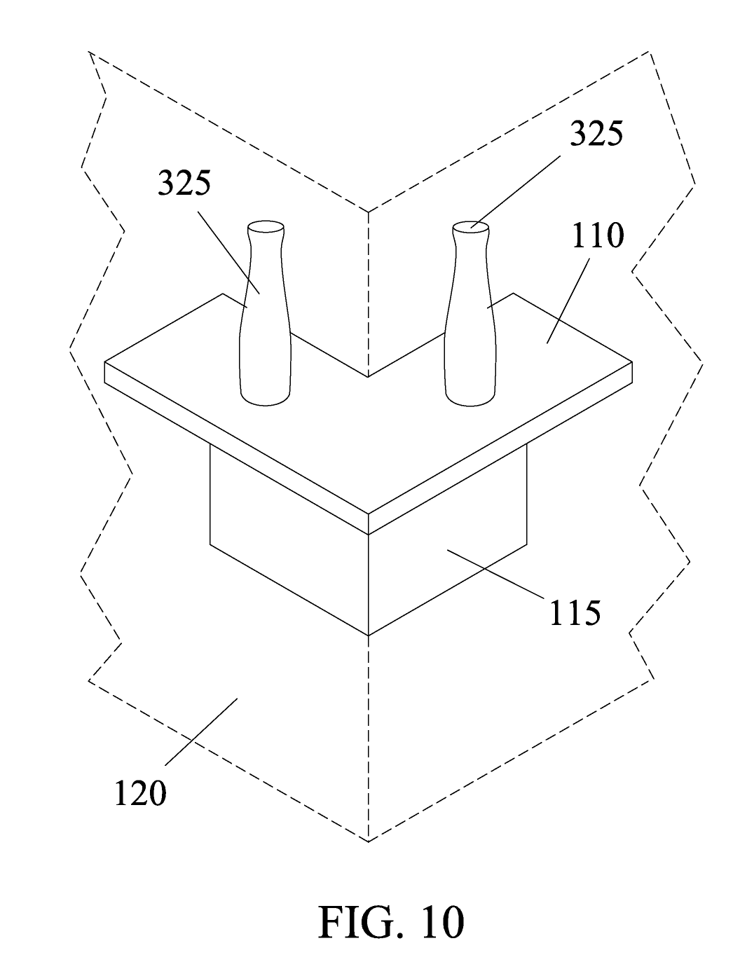

Referring now to FIG. 10, pegs 325 are added to shelf portion 110 to hold coats, hanging baskets or other things. Additionally, the number of pegs used may be selected to match specific design choices by the user.

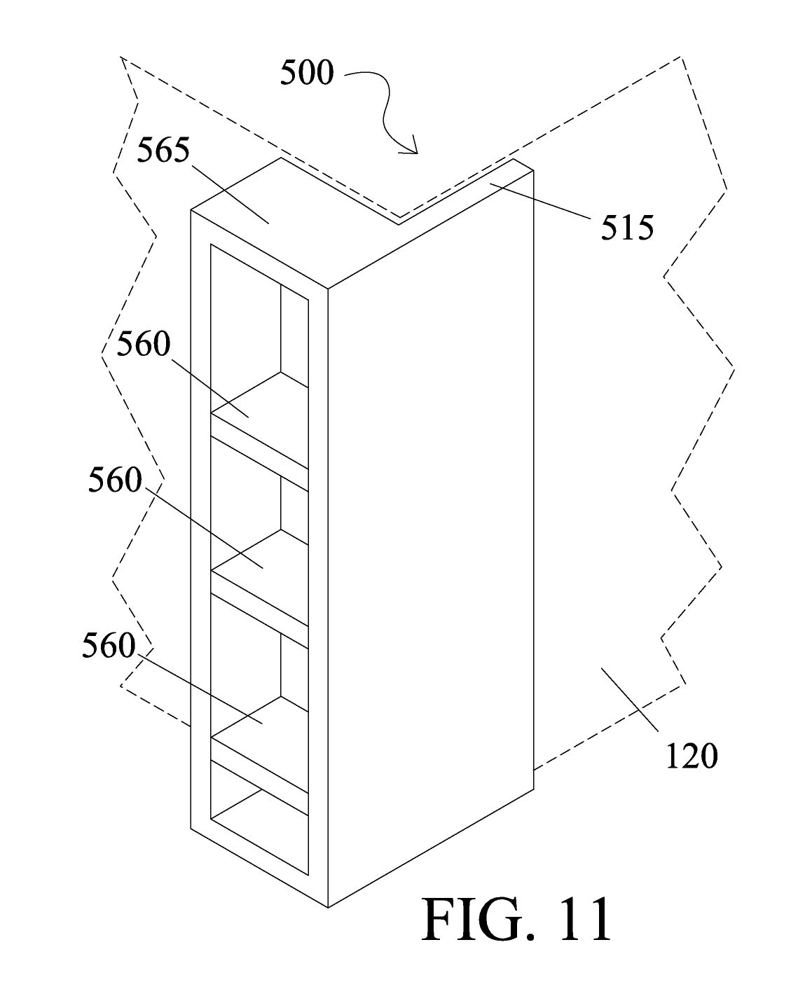

Now referring to FIG. 11, a corner bead magnetic bracket 500 is shown having a curio cabinet 565 attached to a support portion 515 which fits against surface 120 having a metallic corner bead (not shown) as discussed above. Curio cabinet 565 has adjustable shelves 560. Shelves 560 may also be permanently attached.

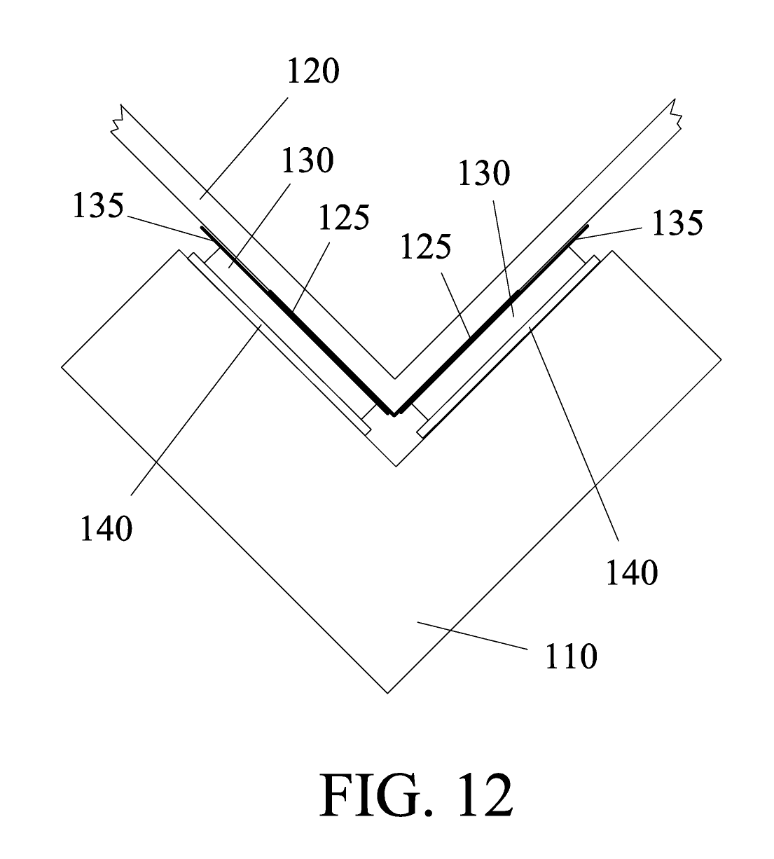

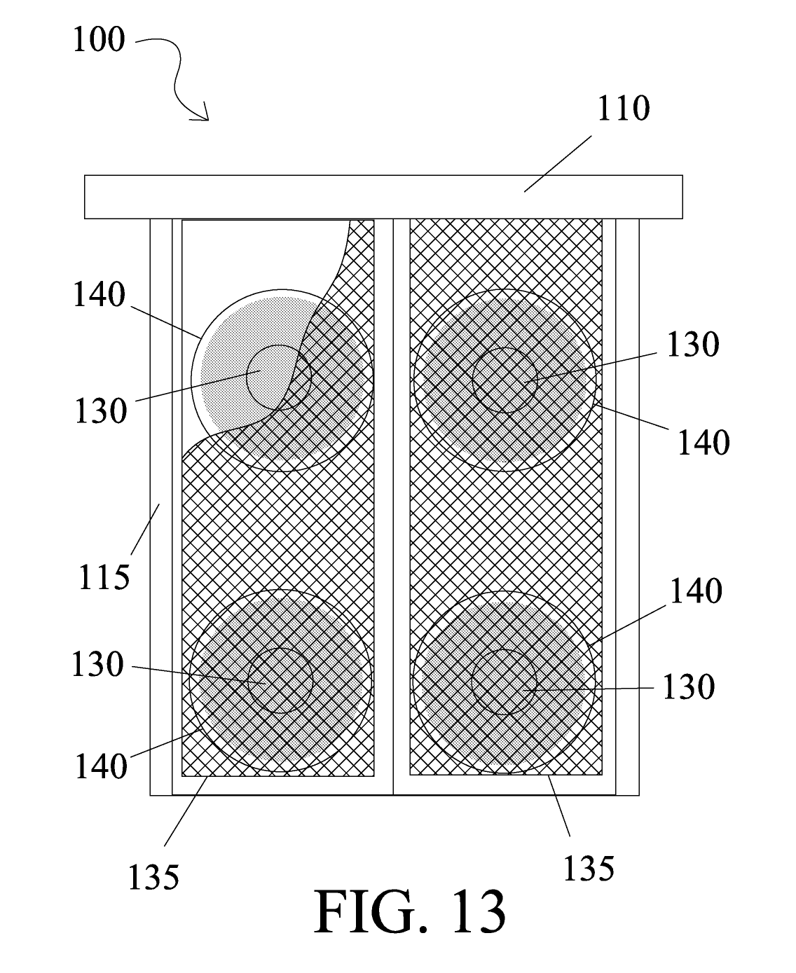

Referring now to FIGS. 12 and 13, a corner bead magnetic bracket is shown with the addition of a washer 140 between support portion 115 and magnet 130 to increase the magnetic density thereby improving the holding power. Although a washer is used, any sufficiently thin magnetic material such as a sheet metal cutout could be used.

Although the instant invention has been described in relation to particular embodiments thereof, many other variations and modifications and other uses will become apparent to those skilled in the art.

What is claimed is:

1. A corner bead magnetic bracket for use on a surface having a metallic corner section comprises:
a support portion;
said support portion having a surface facing side:
at least one magnet disposed on said surface facing side, and
a display portion attached to said support portion.

2. The corner bead magnetic bracket for use on a surface having a metallic corner section according to claim 1 wherein said display portion is a shelf.

3. The corner bead magnetic bracket for use on a surface having a metallic corner section according to claim 2 further comprising at least one peg disposed on said shelf portion.

4. The corner bead magnetic bracket for use on a surface having a metallic corner section according to claim 2 further comprising a candle holder disposed on said shelf portion.

5. The corner bead magnetic bracket for use on a surface having a metallic corner section according to claim 1 wherein said display portion is a vase.

6. The corner bead magnetic bracket for use on a surface having a metallic corner section according to claim 1 wherein said display portion is a curio cabinet.

7. The corner bead magnetic bracket for use on a surface having a metallic corner section according to claim 1 wherein said support portion is vertically orientated.

8. The corner bead magnetic bracket for use on a surface having a metallic corner section according to claim 1 wherein said support portion is horizontally orientated.

9. The corner bead magnetic bracket for use on a surface having a metallic corner section according to claim 1 wherein said support portion comprises two perpendicular portions joined along a common vertex.

10. The corner bead magnetic bracket for use on a surface having a metallic corner section according to claim 9 wherein said support portion is adapted to fit on an outside corner section.

11. The corner bead magnetic bracket for use on a surface having a metallic corner section according to claim 9 wherein said support portion is adapted to fit on an inside corner section.

12. The corner bead magnetic bracket for use on a surface having a metallic corner section according to claim 9 wherein said support portion is adapted to fit on a horizontal corner section.

13. The corner bead magnetic bracket for use on a surface having a metallic corner section according to claim 1 wherein said display portion is adapted to hold a light.

14. The corner bead magnetic bracket for use on a surface having a metallic corner section according to claim 1 further comprising a friction layer disposed between said at least one magnet and said surface.

15. The corner bead magnetic bracket for use on a surface having a metallic corner section according to claim 14 wherein said friction layer is a sandpaper layer.

16. The corner bead magnetic bracket for use on a surface having a metallic corner section according to claim 14 wherein said friction layer is a rubber layer.

17. The corner bead magnetic bracket for use on a surface having a metallic corner section according to claim 1 further comprising at least one magnetic metal cutout disposed between said support portion and said at least one magnet.

18. The corner bead magnetic bracket for use on a surface having a metallic corner section according to claim 17 wherein said at least one magnetic metal cutout is a washer.
